(19) United States
(12) Patent Application Publication
(10) Pub. No.: US 2022/0003619 A1
(43) Pub. Date: Jan. 6, 2022

(54) STRAIN SENSOR UNIT AND EXTENSION REGULATING ASSEMBLY

(71) Applicant: Yamaha Corporation, Hamamatsu (JP)

(72) Inventors: Yasuro OKUMIYA, Morimachi (JP); Yohei WADA, Hamamatsu (JP)

(21) Appl. No.: 17/480,901

(22) Filed: Sep. 21, 2021

Related U.S. Application Data
(63) Continuation of application No. PCT/JP2020/009715, filed on Mar. 6, 2020.

(30) Foreign Application Priority Data
Mar. 22, 2019 (JP) 2019-055118

(51) Int. Cl. G01L 5/10; G01L 1/22

(52) U.S. Cl. CPC G01L 5/10; G01L 1/22

(57) ABSTRACT

A strain sensor unit includes a filamentous or strip-shaped strain sensor element configured to stretch in a longitudinal direction, and an extension regulator coupled to the strain sensor element and configured to set an initial value of an amount of extension of the strain sensor element.

### CROSS-REFERENCE TO RELATED APPLICATIONS

This application is a continuation application of International Application No. PCT/JP2020/009715, filed on Mar. 6, 2020, which claims priority to Japanese Patent Application No. 2019-055118 filed in Japan on Mar. 22, 2019. The entire disclosures of International Application No. PCT/JP2020/009715 and Japanese Patent Application No. 2019-055118 are hereby incorporated herein by reference.

### BACKGROUND

### Technological Field

The present invention relates to a strain sensor unit and an extension regulating assembly.

### Background Information

Various attempts have been made to detect the movement of a measurement object such as a person or an animal by means of a sensor and to convert the measurement into numerical data.

The present applicant has filed an application for as a device that detects the movement of these measurement objects, a strain sensor unit that employs a filamentous or strip-shaped strain sensor element for detecting longitudinal stretch and contraction (refer to Japanese Laid-Open Patent Publication No. 2017-211215).

The strain sensor unit disclosed in the publication described above includes a filamentous or strip-shaped strain sensor element, and a pair of adhesive sheets overlaid on both ends of the strain sensor element. By means of the attachment of a pair of adhesive sheets to a measurement object, the positional displacement of the strain sensor element of the strain sensor unit can be suppressed and the movement of the measurement object site can be measured relatively accurately.

On the other hand, as a result of diligent research by the present inventors, it was found that measurement accuracy of a strain sensor element can be increased by fixing the strain sensor element, which has been extended to a certain degree, to the measurement object in order to increase the linearity. It was also found that there are cases in which it is better to set the degree to which the strain sensor element should be extended in advance, in accordance with the purpose of use, measurement object, and the like.

This disclosure was made in response to these circumstances, and an object of this disclosure is to provide a strain sensor unit and an extension regulating assembly that can improve the measurement accuracy by increasing the linearity of the strain sensor element.

### SUMMARY

A strain sensor unit according to one aspect of this disclosure comprises a filamentous or strip-shaped strain sensor element configured to stretch in a longitudinal direction, and an extension regulator coupled to the strain sensor element and configured to set an initial value of an amount of extension of the strain sensor element.

According to another aspect of this disclosure, the extension regulating assembly is deformable in accordance with extension of a filamentous or strip-shaped strain sensor element configured to stretch in a longitudinal direction, and the extension regulating assembly is configured to set an initial value of an amount of extension of the strain sensor element.

### BRIEF DESCRIPTION OF THE DRAWINGS

Referring now to the attached drawings which form a part of this original disclosure:

FIG. 1 is a schematic side view showing a strain sensor unit according to one embodiment of this disclosure;

FIG. 2 is a schematic plan view of the strain sensor unit of FIG. 1;

FIG. 3 is a schematic side view showing the state of the strain sensor unit of FIG. 1 with the extension regulating assembly removed;

FIG. 4 is a schematic side view showing the state of the strain sensor unit of FIG. 1 with the unit attached to a measurement object;

FIG. 5 is a schematic side view showing an extension regulating assembly according to a different embodiment than the extension regulating assembly of FIG. 3;

FIG. 6 is a schematic side view showing the state of a strain sensor unit in which the extension regulating assembly of FIG. 5 has been attached with the unit attached to a measurement object;

FIG. 7 is a schematic rear view (bottom view) showing an extension regulating assembly according to a different embodiment than the extension regulating assemblies of FIGS. 3 and 5;

FIG. 8 is a schematic side view showing the state of the strain sensor unit in which the extension regulating assembly of FIG. 7 has been attached with the unit attached to a measurement object; and

FIG. 9 is a schematic rear view (bottom view) showing an extension regulating assembly according to a different embodiment than the extension regulating assemblies of FIGS. 3, 5, and 7.

### DETAILED DESCRIPTION OF THE EMBODIMENTS

Selected embodiments will now be explained in detail below, with reference to the drawings as appropriate. It will be apparent to those skilled in the art from this disclosure that the following descriptions of the embodiments are provided for illustration only and not for the purpose of limiting the invention as defined by the appended claims and their equivalents.

A strain sensor unit according to one aspect of this disclosure comprises a filamentous or strip-shaped strain sensor element configured to stretch in the longitudinal direction, and an extension regulator that sets the initial value of the amount of extension of the strain sensor element.

It is preferable that the extension regulator be a flexible member.

It is preferable that the extension regulator be folded in the pre-deformation state.

It is preferable that the extension regulator have elasticity.

It is preferable that the extension regulator be connected to both ends of the strain sensor element in the direction of extension.

It is preferable that the length of the extension regulator correspond to the initial value of the amount of extension of the strain sensor element.

The strain sensor unit is further provided with a pair of support portions, which are attached to both ends of the strain sensor element and that are electrically connected to the strain sensor element, and the extension regulator is preferably fixed to the pair of support portions.

It is preferable that the extension regulator be configured to be capable of being attached to/detached from the strain sensor element.

The extension regulating assembly according to another aspect of this disclosure can be deformed in accordance with the extension of a filamentous or strip-shaped strain sensor element that stretches in the longitudinal direction, and sets the initial value of the amount of extension of the strain sensor element.

Since the strain sensor unit according to one aspect of this disclosure includes an extension regulator that sets the initial value of the extension amount of the strain sensor element, the measurement accuracy can be improved by increasing the linearity of the strain sensor element. In addition, the extension regulating assembly according to another aspect of this disclosure is able to increase the linearity of the strain sensor element in order to improve the measurement accuracy of the strain sensor element.

An embodiment of this disclosure will be described in detail below with reference to the drawings as appropriate.

### First Embodiment

### Strain Sensor Unit

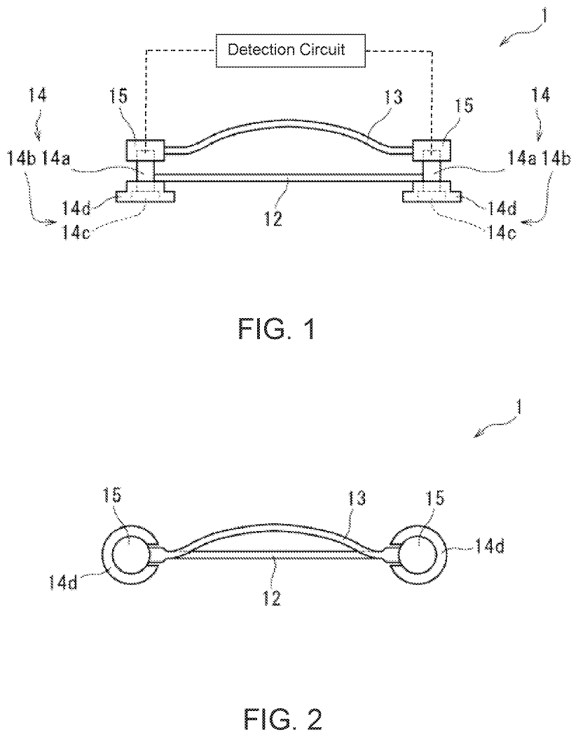

The strain sensor unit 1 of FIGS. 1 to 4 comprises a filamentous or strip-shaped strain sensor element 12 (filamentous strain sensor elements are shown in FIGS. 1 to 4) configured to stretch (be elastic) in the longitudinal direction, and an extension regulator (extension amount regulating part) 13 that is coupled to the strain sensor element 12 and sets the initial value of the extension amount of the strain sensor element 12. The extension regulator 13 is configured to be capable of deformation in accordance with the extension of the strain sensor element 12. The extension regulator 13 is an extension regulator that sets the initial value of the extension amount during use of the strain sensor element 12. In addition, the strain sensor unit 1 has an attachment portion 14 which is configured to attach the strain sensor element 12 in an extended state to a measurement object, and a pair of connecting portions 15 that connects the extension regulator 13 and the strain sensor element 12. The extension regulator 13 and the pair of connecting portions 15 constitute the extension regulating assembly (extension amount regulating member) 2, which is one aspect of this disclosure. The “strip shape” of the strain sensor element 12 means a long shape greater in length than width, and includes a configuration in which the width and length partially change. The “initial value of the extension amount during use” means the extension amount that corresponds to the reference state of a measurement object, when the strain sensor unit 1 is attached to the measurement object.

The strain sensor unit 1 is configured to measure resistance values at both ends of the strain sensor element 12 by a detection circuit, so that it is possible to measure changes in the length of a surface (for example, a skin) of a measurement object site that changes in accordance with motion of the measurement object site.

Strain Sensor Element

The strain sensor element 12 is attached to a measurement object so as to extend in one direction overall. The strain sensor element 12 is fixed to the measurement object at both ends in the direction of extension. The strain sensor element 12 is a stretchable sensor, and stretches, and then contracts by the stretched length to return to its original length, i.e., the length before being stretched. The strain sensor element 12 cannot contract further than the original length. The strain sensor element 12 can be any strain sensor element that has elasticity and whose electrical characteristics change in accordance with its stretch and contraction, and a strain resistance element whose electrical characteristics change in accordance with its stretch and contraction is suitably used. In particular, a CNT strain sensor that uses carbon nanotubes (hereinafter also referred to as “CNT”) can be suitably used as the strain sensor element 12.

In the case that the strain sensor element 12 is filamentous, the strain sensor element 12 is configured to include a CNT bundle. This CNT bundle is a fiber bundle in which a plurality of CNTs (single fibers) are substantially oriented in the longitudinal direction of the CNT elements and covered with resin. The filamentous strain sensor element 12 has a conductive portion formed of CNT bundles, a conductive layer in which CNT fibers and resin are composited, and a resin coating film, in that order radially outwardly from the center. In the strain sensor element 12, the CNT bundle in the center ruptures, and the intervals between ruptures change to cause a change in resistance.

On the other hand, when the strain sensor element 12 is strip-shaped, the strain sensor element 12 is formed of a resin composition containing a large number of CNT fibers. Specifically, the strain sensor element 12 has a plurality of fiber bundle sheets in which a plurality of CNTs (single fibers) are substantially oriented in the longitudinal direction of the CNT element 12, and a resin that coats these fiber bundle sheets. When extension strain is applied to the strain sensor element 12, the internal CNT fibers are cut, and the ends of the CNTs separate, or the extension strain is relaxed, and the ends again conic into contact, which results in a change in the resistance value.

Either a single-walled nanotube (SWNT) or a multi-walled nanotube (MWNT) can be used as the CNT. Among these, MWNTs are preferable from the standpoint of conductivity and heat capacity, and MWNTs having a diameter of 1.5 nm or more and 100 nm or less are most preferable.

The CNTs described above can be fabricated by means of a known method, such as the CVD method, arc method, laser ablation method, DIPS method, or CoMoCAT method. In particular, from the standpoint of the ability to efficiently obtain CNT (MWNT) of the desired size, manufacturing by means of the CVD method using ethylene gas and iron as a catalyst is preferable. In this case, a thin-film of nickel or iron serving as a catalyst can be formed on a substrate, such as a quartz glass substrate or a silicon substrate with air oxide film, and CNT crystals of the desired length grown thereon with a vertical orientation can be obtained.

Attachment Portion

The attachment portion 14 has a pair of support portions 14a that are attached to both ends of the strain sensor element 12 and that can support the strain sensor element 12 in an extended state, and a pair of holding portions 14b that are connected to the pair of support portions 14a and that can fix the strain sensor element 12 to the measurement object in the extended state.

The support portion 14a has a columnar shape, where the axial direction is orthogonal to the direction of extension of the strain sensor element 12. The support portion 14a has rigidity, so that it is possible to support the strain sensor element 12 in the extended state. The support portion 14a is made of a conductive metal and is electrically connected to the strain sensor element 12. The support portion 14a can function as a terminal for the electronic sensing of the detection signals of the strain sensor element 12. The “direction of extension of the strain sensor element” means the stretching direction of the strain sensor element 12 during the use state.

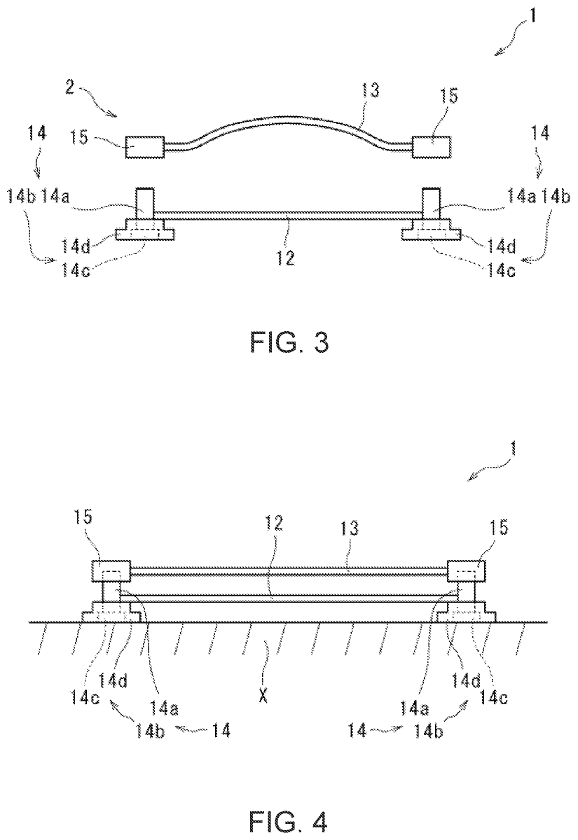

The holding portion 14b has a base portion 14c, which is connected to the support portion 14a and supports the support portion 14a from below (the side connected to the measurement object), and a fixing portion 14d, which is connected around the base portion 14c and fixes the strain sensor element 12 in the extended state to the measurement object. The base portion 14c has a plate shape or a sheet shape, and the planar shape thereof can be appropriately adjusted, but a disk shape is preferable from the standpoint of ease of application. As shown in FIG. 3, the support portion 14a is joined so as to project vertically from the upper surface of the base portion 14c. The fixing portion 14d is preferably formed of a flexible sheet having an adhesive layer on one side. The fixing portion 14d covers the upper surface of the base portion 14c such that the measurement object and the adhesive layer face each other. The fixing portion 14d is also joined to the measurement object as well as to the periphery of the base portion 14c. In addition, the strain sensor element 12 can be supported by the base portion 14c together with the support portion 14a. In this case, the fixing portion 14d can cover the strain sensor element 12 from above together with the base portion 14c such that the measurement object and the adhesive layer face each other. The fixing portion 14d can be annular in a plan view, C-shaped as shown in FIG. 2, U-shaped, or have the form of a truncated annulus. It is preferably that the fixing portion 14d be flexible, whereby adhesiveness to the base portion 14c and the measurement object is improved. In the present Specification, “lower” means the side that faces the measurement object, and “upper” means the opposite side.

Extension Amount Regulation Part

The extension regulator 13 extends in accordance with the extension of the strain sensor element 12. The extension regulator 13 is fixed to the pair of support portions 14a via the pair of connecting portions 15. The extension regulator 13 is a flexible member. The extension regulator 13 is preferably string-shaped. The extension regulator 13 is shaped to have two wide ends and a narrow central portion. The longitudinal length of the extension regulator 13 is set in accordance with an initial length (reference length) of the strain sensor element 12 during use. The initial length of the strain sensor element 12 during use is a length of the strain sensor element 12 in a state in which the strain sensor element 12 stretches to some extent. The “string-shape” of the extension regulator 13 signifies possessing elongation and flexibility. The “string shape” includes net-like (knit-like), woven, and ribbon-like shapes in which a plurality of filamentous bodies are knitted or woven, and the length, width, etc., can be partially changed.

By having flexibility, the extension regulator 13 can easily deform when the strain sensor element 12 extends, and it is possible to easily set the initial value of the extension amount when the strain sensor element 12 is in use. In particular, since the extension regulator 13 is string-shaped, it is a simple matter to set the initial value. As will be described in detail further below, in the strain sensor unit 1, the length of the extension regulator 13 (the length in a state of non-stretch/non-contraction, i.e., the length of the extension regulator 13 fully extended in a linear unstress state) is formed in advance in accordance with the initial length of the strain sensor element 12 during use. That is, the extension regulator 13 is longer than the strain sensor element 12, so that when the strain sensor element 12 is not extended, the extension regulator 13 is slack. Then, by extending the strain sensor element 12 until the extension regulator 13 becomes linear, the strain sensor element 12 can be easily fixed to the measurement object in a state of elongation to the initial value of the extension amount. In addition, since the strain sensor element 12 is extended until the slack extension regulator 13 becomes linear, visual confirmation is a simple matter. That is, the extension regulator 13 has flexibility, deforms in response to the extension of the strain sensor element 12, and linearizes when the extension amount is the initial value in the use state of the strain sensor element 12.

The extension regulator 13 preferably has elasticity. In this case, the extension regulator 13 can include, for example, a synthetic resin, an elastomer, or the like, as the main component. By means of this configuration, the extension regulator 13 can be further extended in a state in which the strain sensor element 12 is fixed to the measurement object. The rigidity of the extension regulator 13 can be decreased by decreasing the width of the central portion. As a result, in the strain sensor unit 1, after the initial value of the extension amount is set when the strain sensor element 12 is in use, even if the extension regulator 13 remains attached to the strain sensor element 12, the extension regulator 13 does not easily interfere with the stretch and contraction of the strain sensor element 12. Accordingly, since it is not required that the extension regulator 13 be removed when the strain sensor unit 1 is used, the handling capability can be improved.

The extension regulator 13 preferably has the same, or more, rigidity as the rigidity of the strain sensor element 12. When the strain sensor unit 1 is manually extended, it is possible not only to visually confirm but also to sense with the fingers that the extension regulator 13 has become linear. Since the extension regulator 13 is an elastic body, it is possible to measure the measurement object in the extended state.

The strain sensor element 12 and the extension regulator 13 are supported spaced apart from each other by means of the support portions 14a. That is, the strain sensor unit 1 has a space between the stretch and contraction region of the strain sensor element 12 and the extension regulator 13. As a result, each element can move independently, and whether the extension regulator 13 is linear can easily be checked visually. The “stretch and contraction region of the strain sensor element” means the region that can stretch and contract in accordance with the movement of the measurement object site of the strain sensor element. That is, in the present embodiment, it is the region between the two ends attached to the attachment portion 14.

### Extension Regulating Assembly

The extension regulating assembly 2 can deform in accordance with the extension of the strain sensor element 12 that stretches and contracts in the longitudinal direction. The extension regulating assembly 2 sets the initial value of the extension amount of the strain sensor element 12.

The extension regulating assembly 2 has a pair of connecting portions 15 at the two ends of the strain sensor element 12 in the direction of extension. As a result, the extension regulator 13 is coupled to the strain sensor element 12 via the pair of support portions 14a and the pair of connecting portions 15, and the extension regulator 13 is connected to both ends of the strain sensor element 12 in the direction of extension at the two ends in the longitudinal direction via the pair of support portions 14a and the pair of connecting portions 15. More specifically, a first end of the extension regulator 13 is coupled to a first end of the strain sensor element 12 via a first portion of the support portions 14a and a first portion of the connecting portions 15, and a second end of the extension regulator 13 is coupled to a second end of the strain sensor element 12 via a second portion of the support portions 14a and a second portion of the connecting portions 15. The strain sensor unit 1 is able accurately to measure the extension amount of the strain sensor element 12 as a result of connection of the extension regulator 13 to the two ends of the strain sensor element 12 in the direction of extension.

The pair of connecting portions 15 and the pair of support portions 14a can be configured to be detachable by means of a male-female structure of snap buttons. As a result, the strain sensor unit 1 can be configured such that the extension regulator 13 can be attached to/detached from the strain sensor element 12,

In the strain sensor unit 1, the extension regulating assembly 2 can be attached only when the initial value of the strain sensor element 12 is set. By means of this configuration, it is possible to use one extension regulator 13 with a plurality of strain sensor units 1, so that the number of the extension regulators 13 can be reduced. In addition, by means of this configuration, for example, the extension regulator 13 can be removed during use of the strain sensor unit 1, in order to prevent the extension regulator 13 from affecting user movement, which makes a more accurate measurement possible. In addition, even if the extension regulator 13 does not stretch and contract, high-level measurements are possible by its removal.

When the strain sensor unit 1 is attached to the measurement object, first, the strain sensor element 12 is extended on both sides in the direction of extension. By extending the strain sensor element 12 on both sides in the direction of extension, the extension regulator 13 deforms in accordance with the extension of the strain sensor element 12. Next, as shown in FIG. 4, the pair of fixing portions 14d are attached to a measurement object X in a state in which the extension regulator 13 deforms until there is no slack, and the strain sensor element 12 is fixed to the measurement object X in a prescribed state of extension.

### Advantages

The strain sensor unit 1 is able to set the initial value of the extension amount of the strain sensor element 12 as a result of the deformation of the extension regulator 13 in response to the extension of the strain sensor element 12. In addition, since the strain sensor unit 1 can extend the strain sensor element 12 until the strain sensor element 12 has high linearity to carry out the measurement, the measurement accuracy can be improved.

The extension regulating assembly 2 can increase the measurement accuracy of the strain sensor element 12 by increasing the linearity of the strain sensor element 12.

### Second Embodiment

### Extension Regulating Assembly

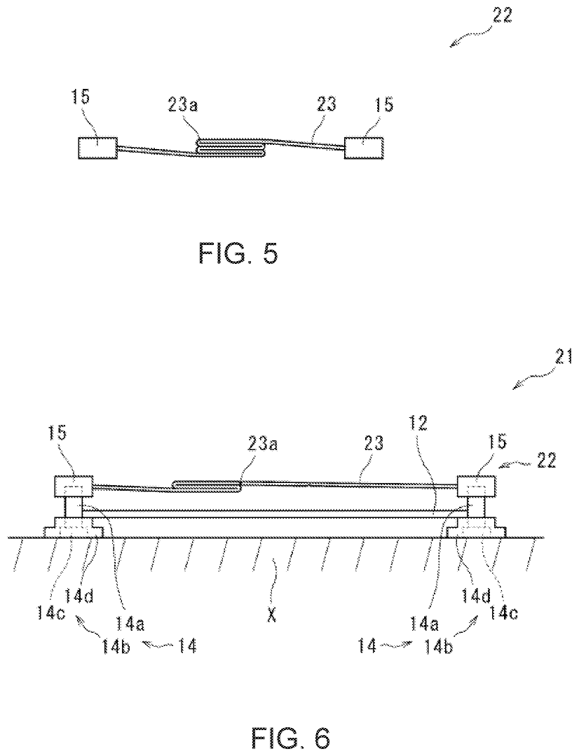

The extension regulating assembly 22 of FIG. 5 can be used instead of the extension regulating assembly 2 of FIG. 3. The extension regulating assembly 22 can be deformed in accordance with the extension of a filamentous or strip-shaped strain sensor element 12 that stretches and contracts in the longitudinal direction, and sets the initial value of the amount of extension of the strain sensor element 12, as shown in FIG. 6. The extension regulating assembly 22 has an extension regulator 23 and the pair of connecting portions 15. The pair of connecting portions 15 is the same as or similar to the pair of connecting portions 15 of the extension regulating assembly 2 of FIG. 3, and the same reference numerals have been assigned and their corresponding descriptions have been omitted.

The extension regulator 23 is used instead of the extension regulator 13 of FIG. 1. The extension regulating assembly 23 sets the initial value of the extension amount of the strain sensor element 12. The extension regulator 23 is configured to be capable of deforming in response to the extension of the strain sensor element 12. The extension regulator 23 is a flexible member. The extension regulator 23 is preferably string-shaped. The extension regulator 23 is connected to both ends of the strain sensor element 12 in the direction of extension.

The extension regulator 23 is strip-shaped and is folded in the pre-deformation state (state before the initial value of the extension amount of the strain sensor element 12 is set). The longitudinal length of the extension regulator 23 is set in accordance with the initial length (reference length) of the strain sensor element 12 when the strain sensor element 12 is in use. The extension regulator 23 has a plurality of folds 23a at prescribed locations in the longitudinal direction, and is configured to be capable of changing the entire length in a stepwise manner by maintaining one or a plurality of desired folds 23a in the folded state (that is, by increasing or decreasing the number of folds 23a to be folded). The extension regulator 23 is configured to be capable of adjusting the initial length of the strain sensor element 12 during use to a length corresponding to the measurement object by maintaining one or a plurality of desired folds 23a in the folded state.

### Strain Sensor Unit

The strain sensor unit 21 of FIG. 6 comprises the filamentous or strip-shaped strain sensor element 12 that stretches and contracts in the longitudinal direction, and the extension regulator 23 that sets the initial value of the extension amount of the strain sensor element 12. The extension regulator 23 is configured to be capable of deforming in response to the extension of the strain sensor element 12. In addition, the strain sensor unit 21 has the attachment portion 14 with which the strain sensor element 12 can be attached to a measurement object in an extended state, and the pair of connecting portions 15 that connects the extension regulator 23 and the strain sensor element 12. As shown in FIG. 6, the extension regulator 23 is coupled to the strain sensor element 12 via the support portions 14a and the connecting portions 15. More specifically, a first end of the extension regulator 23 is coupled to the first end of the strain sensor element 12 via the first portion of the support portions 14a and the first portion of the connecting portions 15, and a second end of the extension regulator 23 is coupled to the second end of the strain sensor element 12 via the second portion of the support portions 14a and the second portion of the connecting portions 15. Aside from the use of the extension regulator 23 in place of the extension regulator 13 of FIG. 1, the strain sensor unit 21 can be configured in the same manner as the strain sensor unit 1 of FIG. 1. With the strain sensor unit 21, when the strain sensor element 12 is extended, the extension regulator 23 deforms, and it is thus possible to measure the extension amount.

### Advantages

In the strain sensor unit 21, the extension regulator 23 is configured to be capable of changing the entire length in a stepwise manner, so that it is possible to adjust the initial value of the extension amount of the strain sensor element 12 in accordance with the measurement site, and the like.

The extension regulating assembly 22 can adjust the initial value of the extension amount of the strain sensor element 12.

By being configured to be detachable with respect to the strain sensor element 12 and by providing a plurality of folds 23a in the extension regulator 23, the extension regulating assembly 22 can be used in a plurality of types of strain sensor units 21.

### Other Embodiments

The above-described embodiments do not limit the configuration of this disclosure. Therefore, in the above-described embodiments, the constituent elements of each part of the embodiment can be omitted, replaced, or added to based on the recitation of the present Specification and common knowledge of the art, all of which shall be interpreted as belonging to the scope of this disclosure.

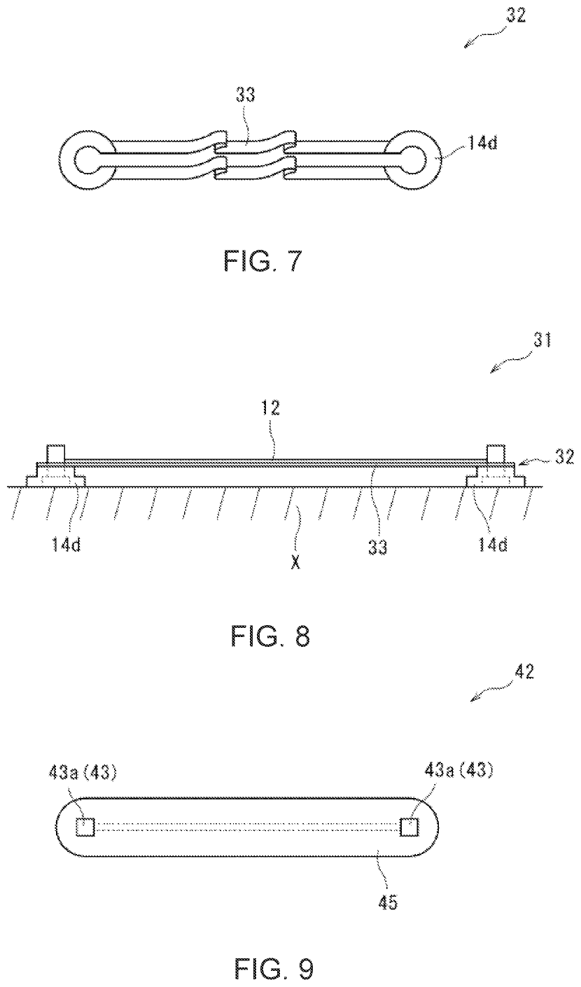

For example, the specific configuration of the extension regulator is not limited the configuration described in the embodiments above. An extension regulator according to another embodiment and an extension regulating assembly provided with this extension regulator will be described with reference to FIGS. 7 to 9.

An extension regulating assembly 32 of FIG. 7 comprises the pair of fixing portions 14d of the strain sensor unit 1 of FIG. 1, and an extension regulator 33 that is bridged between the fixing portions 14d. The fixing portions 14d and the extension regulator 33 are integrally formed. The extension regulator 33 and the fixing portions 14d are formed by patterning an adhesive layer and a release paper of a double-sided tape having a release paper on both sides. Specifically, the pair of fixing portions 14d are formed of the adhesive layer, and the extension regulator 33 is formed of the release paper that connects the adhesive layers to each other (the fixing portions 14d to each other). As shown in FIG. 8, the extension regulator 33 is coupled to the strain sensor element 12 via the support portions 14a and the fixing portions 14d. More specifically, a first end of the extension regulator 33 is coupled to the first end of the strain sensor element 12 via the first portion of the support portions 14a and a first portion of the fixing portions 14d, and a second end of the extension regulator 33 is coupled to the second end of the strain sensor element 12 via the second portion of the support portions 14a and a second portion of the fixing portions 14d. The extension regulator 33 is strip-shaped. The longitudinal length of the extension regulator 33 is set in accordance with the initial length (reference length) of the strain sensor element 12 in the use state.

A procedure for using a strain sensor unit 31 provided with this extension regulating assembly 32 will be described with reference to FIG. 8. When the strain sensor unit 31 is attached to the measurement object X, first, the strain sensor element 12 is extended on both sides in the direction of extension. By extending the strain sensor element 12 on both sides in the direction of extension, the extension regulator 33 deforms in response to the extension of the strain sensor element 12. Next, the pair of fixing portions 14d are attached to the measurement object X in a state in which the extension regulator 33 deforms until there is no slack. In a state in which the extension regulator 33 has deformed, the extension regulator 33 and the strain sensor element 12 may come into contact, but each can deform independently. Before or during deformation, there is a space between the extension regulator 33 and the strain sensor element 12. In addition, the extension regulator 33 can be peeled off after attachment of the pair of fixing portions 14d. As a result, the strain sensor element 12 can be fixed to the measurement object X in a prescribed extended state and in a state in which stretch/contraction is possible.

An extension regulating assembly 42 of FIG. 9 has an elastic, strip-shaped attachment portion 45, and an extension regulator 43 provided on the lower surface of the attachment portion 45. The extension regulator 43 is configured as a pair of electrode connecting portions 43a that are connected to a pair of electrodes provided at two ends of the strain sensor element 12. In this embodiment, the extension regulator 43 is coupled to the strain sensor element 12 via the electrodes provided on the strain sensor element 12. The interval between the pair of electrode connecting portions 43a is set in accordance with the initial length (reference length) of the strain sensor element 12 when the strain sensor element 12 is in use. By stretching the pair of electrodes of the strain sensor element 12 to the position for being connected to the pair of electrode connecting portions 43a, the extension regulating assembly 42 is able to set the initial value of the extension amount of the strain sensor element. By means of the extension regulating assembly 42, it is possible easily and reliably to fix the strain sensor element to the measurement object. Since the strain sensor element can be covered from the upper surface side, the extension regulating assembly 42 has the excellent function of protecting the strain sensor element, for example, by means of waterproofing. Here, in the extension regulating assembly 42, the adhesive layer of the portion overlapping the strain sensor element can be omitted. As a result, the extension regulating assembly 42 can be deformed independently of the strain sensor element. During extension or non-extension, there is a space between the extension regulator 42 and the strain sensor element.

For example, a filamentous or strip-shaped elastomer that changes color due to extension, a mesh whose mesh opening changes when elongated, or the like, with which it is possible to set the initial value of the extension amount of the strain sensor element from changes in appearance, can be used as the extension regulator. In addition, it is also possible to use an extension regulator that breaks when extended by a certain amount or more to set the length at the time of breakage as the initial length of the strain sensor element.

The extension regulator can be bellows-shaped. In addition, the extension regulator can be a slack thread disposed at a position visible from above. As a result of the arrangement of the extension regulator in a position visible from above, it is possible to visually confirm that it has been stretched straight, and to carry out a measurement in a state of optimum linearity.

As described above, the strain sensor unit according to one aspect of this disclosure can improve the measurement accuracy by increasing the linearity of the strain sensor element, so that it is suitable for measuring the movement of people, and the like.

What is claimed is:

1. A strain sensor unit comprising:
a filamentous or strip-shaped strain sensor element configured to stretch in a longitudinal direction; and
an extension regulator coupled to the strain sensor element and configured to set an initial value of an amount of extension of the strain sensor element.

2. The strain sensor unit according to claim 1, wherein
the extension regulator is flexible.

3. The strain sensor unit according to claim 1, wherein
the extension regulator is folded in a state prior to deformation.

4. The strain sensor unit according to claim 1, wherein
the extension regulator has elasticity.

5. The strain sensor unit according to claim 1, wherein
the extension regulator is connected to both ends of the strain sensor element in a direction of extension of the strain sensor element.

6. The strain sensor unit according to claim 1, wherein
the extension regulator has a length that corresponds to the initial value of the amount of extension of the strain sensor element.

7. The strain sensor unit according to claim 1, further comprising a pair of support portions that are attached to both ends of the strain sensor element and that are electrically connected to the strain sensor element, and
the extension regulator is fixed to the pair of support portions.

8. The strain sensor unit according to claim 1, wherein
the extension regulator is attachable to and detachable from the strain sensor element.

9. An extension regulating assembly that is deformable in accordance with extension of a filamentous or strip-shaped strain sensor element configured to stretch in a longitudinal direction, the extension regulating assembly being configured to set an initial value of an amount of extension of the strain sensor element.
